(19) United States
(12) Patent Application Publication
(10) Pub. No.: US 2003/0193575 A1
(43) Pub. Date: Oct. 16, 2003

(54) Removable apparatus for use in a digital recording/reproducing device for outputing position information, and a digital recording/reproducing device having the same

(76) Inventor: Haruyuki Yoshioka, Suwon-City (KR)

Correspondence Address: Joseph J. Buczynski, Roylance, Abrams, Berdo & Goodman, L.L.P., Suite 600, 1300 19th Street, N.W., Washington, DC, 20036, US

(21) Appl. No.: 10/409,582

(22) Filed: Apr. 9, 2003

(30) Foreign Application Priority Data
Apr. 16, 2002 (KR) 2002-20536

(51) Int. Cl. H04N 5/225

(52) U.S. Cl. 348/207.99

(57) ABSTRACT

A removable apparatus for use in a digital recording/reproducing device, for outputting position information, and a digital recording/reproducing device having the same. The removable apparatus has a global positioning system (GPS) having a receiver for externally receiving data for position calculation, a calculator for calculating the position information using the data for position calculation, a connecting portion comprising a fixing portion removably secured to an external device and a transmitting terminal for transmitting the position information to the external device, and a transmitter for transmitting the position information calculated by the calculator to the external device connected to the fixing portion through the transmitting terminal. Preferably, the GPS terminal further includes a power supply for supplying a driving power to the receiver, the calculator and the transmitter. Accordingly, by matching the image of the object with the position information of the image, and then recording the same on the recording medium, it becomes easier to check the position information of the image being displayed during the reproducing of the recording medium.

This application claims benefit under 35 U.S.C. §119 from Korean Patent Application No. 2002-20536, filed on Apr. 16, 2002, the entire content of which is incorporated herein by reference.

### BACKGROUND OF THE INVENTION

1. Field of the Invention

The present invention generally relates to a digital recording/reproducing device, and more particularly, to a digital recording/reproducing device capable of recording information pertaining to a position of an object of which an image is being recorded by the digital recording/reproducing device.

2. Description of the Related Art

Generally, a digital recording/reproducing device has the function of a video camera that captures an image of an object, and of a video recorder that records the image of the object. An operator of such a digital recording/reproducing device can take images of an object and record the images of the object on a recording medium, such as a magnetic tape and a memory stick. Furthermore, the operator can check the images of the object by reproducing the image from the recording medium. Such a reproduced image is typically displayed through a view finder.

The advantage of a digital recording/reproducing device is that it is a portable image capturing device that is easy to use and can capture an image of a desired object in any place, namely, outside, at a concert, and so on. However, the digital recording/reproducing device has a disadvantage in that the operator cannot check the position of the object when displaying the reproduced image from the recording medium.

In order to overcome the above-mentioned disadvantage, conventionally, a global positioning system (GPS) has been used. One method that uses GPS is to find the position of the object by calculating the position information through the portable GPS terminal during the time that the digital recording/reproducing device is capturing an image of the object, and then matching that time with the time indicated by a portable GPS terminal. Another method is to record the image of the object together with the position information calculated from a built-in GPS terminal while the image is being captured.

According to the first method mentioned above, the operator experiences an inconvenience of having to carry the portable GPS terminal for every shooting of the object. Additionally, because the portable GPS terminal requires a memory of enough storage capacity to store the position information calculated by the portable GPS terminal, the unit price of the portable GPS terminal is quite expensive. The operator also experiences an inconvenience because he or she needs to check the respective time on the screen by connecting to a personal computer in order to match the time of the position information stored in the portable GPS terminal and the time of the image information stored in the recording medium of the digital recording/reproducing device.

According to the second method mentioned above that uses the built-in GPS terminal, a predetermined time elapses from when the power is supplied to the GPS terminal until the position measurement is made from which the position of the object is calculated. Accordingly, from the time power is supplied to a certain point in time, the position information is not properly recorded on the recording medium. Further, if the image shooting is performed in places where there is unstable reception of the signals from the GPS satellites, for example, if the shooting is performed in the skyscraper where the satellite signal reception is usually blocked, the position information is not calculated, and thus the position information of the image cannot be recorded on the recording medium.

### SUMMARY OF THE INVENTION

Accordingly, it is an object of the present invention to provide a GPS terminal with which a user of a digital recording/reproducing device does not experience the inconvenience of having to carry a portable GPS terminal for every shooting in order to check the position information of an object.

Another object of the present invention is to provide a GPS terminal capable of solving the problem in which an error is generated in the position information due to a certain amount of time lapse from when the power is supplied until the position measurement is taken.

The above objects, as well as other objects, are substantially accomplished by a global positioning system (GPS) terminal according to an embodiment of the present invention, which includes a receiver for receiving data for position calculation transmitted from a satellite; a calculator for calculating the position information using the data for position calculation; a connecting portion comprising a fixing portion for removably connecting to an external device, and a transmitting terminal for transmitting the position information to the external device; and a transmitter for transmitting the position information calculated by the calculator to the external device connected to the fixing portion through the transmitting terminal. Preferably, further provided is a power supply for supplying power to the receiver, the calculator and the transmitter.

The above objects are also substantially accomplished by a digital recording/reproducing device according to an embodiment of the present invention, including an image capturing unit for capturing an image of an object; a recording unit for recording an image of the object taken by the image capturing unit on a recording medium; a GPS terminal for externally receiving a data for position calculation, and calculating the position information using the data for position calculation as received; and a connecting portion provided on a part of a casing that houses the image capturing unit and the recording unit therein, the connecting portion comprising a fixing portion for removably connecting the position information outputting apparatus with the casing, and a transmitting terminal for transmitting the position information output from the position information outputting apparatus to the recording unit.

Preferably, when the position information is received through the transmitting terminal, the recording unit records the image of the object on the recording medium together with the position information.

The position information outputting apparatus includes a receiver for externally receiving the data for position calculation; a calculator for calculating the position information using the data for position calculation; and a transmitter for transmitting the position information calculated at the calculator to the recording unit through the transmitting terminal. The position information outputting apparatus further includes a power supply for supplying a driving power to the receiver, the calculator and the transmitter. The position information outputting apparatus is, for example, a GPS terminal.

According to an object of the present invention, because the images of the object are recorded in association with the calculated position information at the time the image of the object is being captured, it is easier to check the position information of the object during the reproducing of the recorded images.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram showing an example of a digital recording/reproducing device according to an embodiment of the present invention;

FIG. 2 is a sectional view showing an example of the connecting unit of FIG. 1;

FIG. 3 is a block diagram showing an example of the calculating unit of FIG. 1;

FIG. 4 is a block diagram showing an example of the transmitting unit of FIG. 1;

FIG. 5 is a block diagram showing an example of the shooting unit of FIG. 1 in greater detail; and

FIG. 6 is a block diagram showing a recording unit of FIG. 1 in greater detail.

### DETAILED DESCRIPTION OF THE PREFERRED EMBODIMENTS

Reference will now be made in detail to certain embodiments of the present invention.

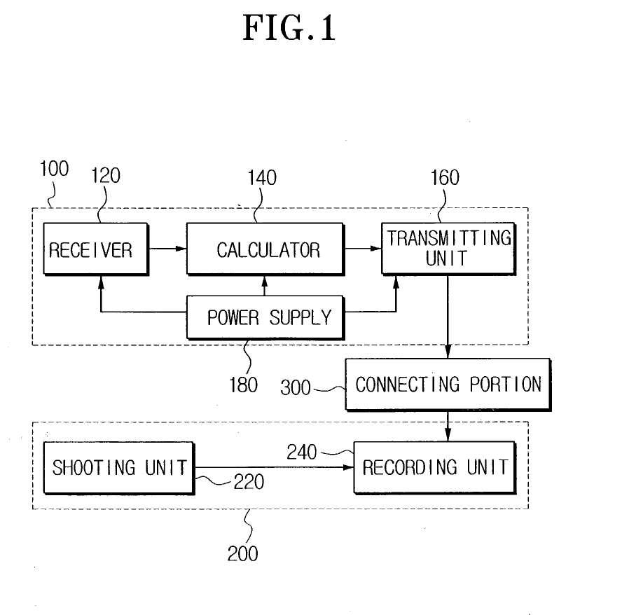

FIG. 1 is a block diagram showing an example of a digital recording/reproducing device according to an embodiment of the present invention, which is capable of recording position information of an object whose image is being captured. Hereinafter, the digital recording/reproducing device will be described.

As shown in FIG. 1, the digital recording/reproducing device includes a position information outputting apparatus 100 for calculating and outputting position information, a recording system 200 for shooting and taking images of an object and recording the taken images in association with the position information output from the position information outputting apparatus 100, and a connecting portion 300 for separably connecting the position information outputting apparatus 100 with the recording system 200 and for transmitting the position information from the position information outputting apparatus 100 to the recording system 200. Accordingly, the recording system 200 is capable of recording the images of the object together with the position information received through the connecting portion 300. In reproducing of the recording medium, the operator can check the position information of the image on the recording medium. Throughout the description of the embodiments, a GPS terminal will be described as the position information outputting apparatus 100 by way of example.

The position information outputting apparatus 100 includes a receiver 120, a calculator 140, a transmitter 160 and a power supply 180. The receiver 120 receives the data to be used for position calculation from the satellite. The calculator 140 calculates the position information corresponding to the current position of the object based on the data for position calculation received at the receiver 120. The transmitter 160 transmits the position information calculated at the calculator 140 to the recording system 200 through the connecting portion 300. The power supply 180 supplies independent power to the position information outputting apparatus 100 irrespective of whether or not the position information outputting apparatus 100 is connected to the recording system 200 through the connecting portion 300. That is, the power supply 180 supplies independent power to the receiver 120, to the calculator 140 and to the transmitter 160, respectively.

Meanwhile, the recording system 200 includes an image capturing device, referred to as a shooting unit 220, and a recording unit 240. The shooting unit 220 takes the images of the object, and converts the images into a format suitable for recording. The recording unit 240 combines the image output from the shooting unit 220 with the position information received through the connecting portion 300 and records the combined data on the recording medium.

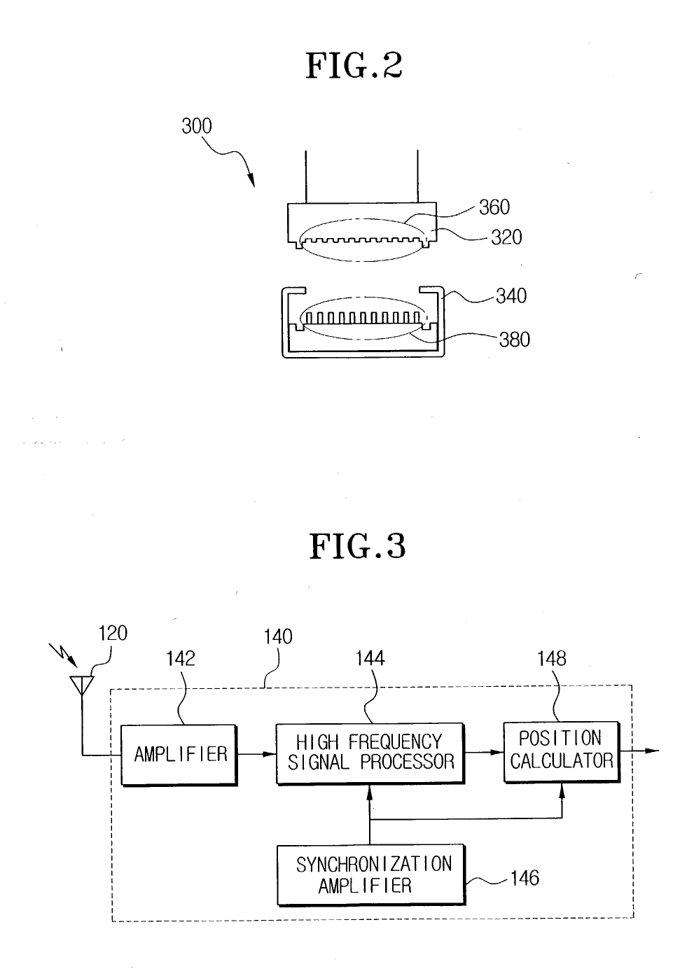

FIG. 2 is a sectional view showing an example of connecting portion 300. Referring to FIG. 2, the connecting portion 300 includes a first fixing portion 320 and a second fixing potion 340, and a first transmitting terminal 360 and a second transmitting terminal 380. The first fixing portion 320 and the first transmitting terminal 360 are provided on part of a casing of the recording system 200. Further, the second fixing portion 340 and the second transmitting terminal 380 are provided on part of a casing of the recording system 200. Preferably, the second fixing portion 340 and the second transmitting terminal 380 are constructed based on the common specification so as to permit mounting of necessary accessories for shooting.

Accordingly, the first and the second fixing portions 320 and 340 are formed to have a structure that allows separable connection. The first and the second transmitting terminals 360 and 380 are connected with each other by the first and the second fixing portions 320 and 340, thereby receiving position information from the position information outputting apparatus 100 and transmitting the received information to the recording system 200. Accordingly, the operator no longer experiences an inconvenience of having to connect the position information outputting apparatus 100 to the computer to check the position of the object.

FIG. 3 is a block diagram showing an example of the calculator 140 of FIG. 1. The calculator 140 includes an amplifier 142, a high frequency signal processor 144, a synchronization amplifier 146 and a position calculator 148. The amplifier 142 analogue-amplifies the position calculation data received at an antenna 120, that is, at the receiver 120 that receives the data from the satellites for position calculation. The synchronization amplifier 146 provides the synchronization signal of the data used for position calculation that is amplified at the amplifier 142. The high frequency signal processor 144 high-frequency signal processes the data for position calculation that is amplified at the amplifier 142, based on the synchronization signal provided by the synchronization amplifier 146. The position calculator 148 calculates the current position of the object based on the synchronization signal provided by the synchronization amplifier 146 and the data for position calculation output from the high frequency signal processor 144.

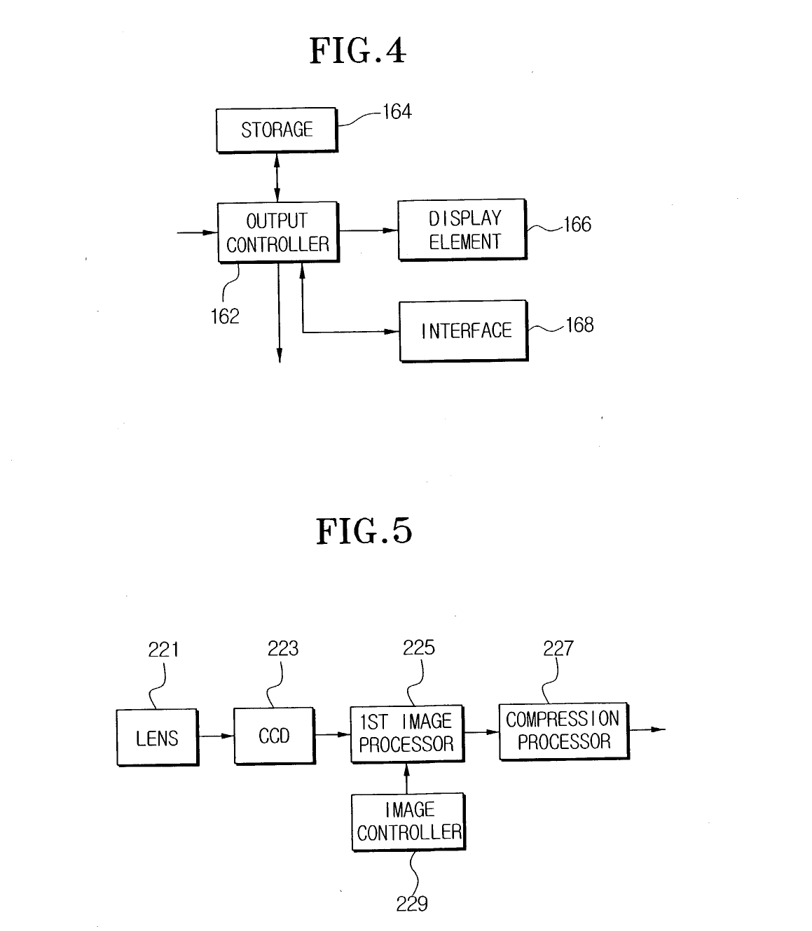

FIG. 4 is a block diagram showing an example of the transmitter 160 of FIG. 1. As shown, the transmitter 160 includes an output controller 162, a storage 164, a display element 166 and an interface 168. The output controller 162 outputs the position information calculated from the position calculator 148 to a corresponding part via a data transfer bus. The storage 164 stores the position information output from the output controller 162. The display element 166 displays the position information output from the output controller 162 in a display device such as a liquid crystal display (LCD). The interface 168 outputs the position information output from the output controller 162 to external devices such as a computer and so on. Preferably, the output controller 162 transmits the position information calculated at the position calculator 148 when the position information outputting apparatus 100 is connected to the recording system 200 through the connecting portion 300. The output controller 162 stores the position information calculated at the position calculator 148 in the storage 164 when the position information outputting apparatus 100 is not connected with the recording system 200.

FIG. 5 is a block diagram showing an exemplary of the shooting unit 220 of FIG. 1 in greater detail. The shooting unit 220 includes a lens 221, a charge coupled device (CCD) 223, a first image processor 225, an image controller 229, and a compression processor 227. The lens 221 is used for capturing images of the object. The CCD 223 accumulates the images of the object and transmits the accumulated images. The first image processor 225 converts the image provided by the CCD 223 into a signal suitable for recording. The image controller 229 controls the signal conversion of the first image processor 225. The compression processor 227 compresses the images converted at the first image processor 225 into a predetermined recording format of the recording system 200.

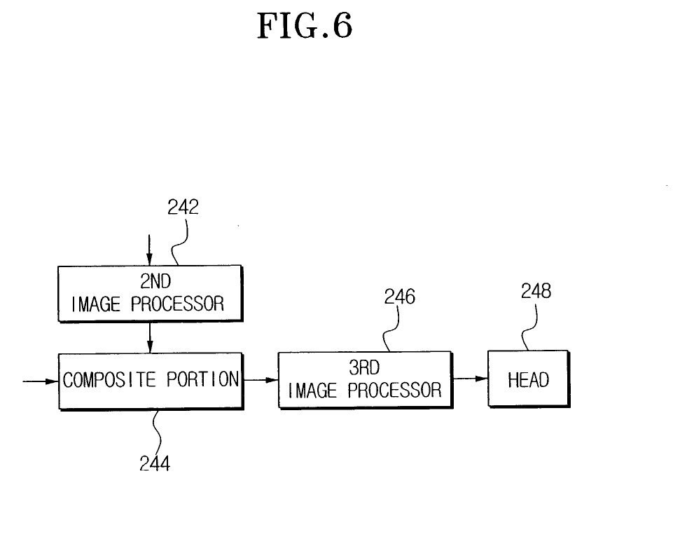

FIG. 6 is a block diagram showing an example of the recording unit 240 of FIG. 1 in greater detail. The recording unit 240 includes a second image processor 242, a combining portion 244, a third image processor 246 and a head 248. The second image processor 242 converts the position information provided through the connecting portion 300 into a format suitable for recording on the recording medium. The combining portion 244 combines the compressed image output from the compression processor 227 with the position information into a single signal. The third image processor 246 converts the combined signal of image and position information from the combining portion 244 into a format suitable for recording on the recording medium. The head 248 records the signal converted at the third image processor 246 on the recording medium. As described below, a magnetic tape is used as the recording medium by way of an example.

According to an embodiment of the present invention, the image of the object and the position information are matched with each other before being recorded on the recording medium. As a result, it is easy for the operator to check the position information of the displayed images during reproducing of the recording medium.

Further, since the position information outputting apparatus 100 operates on the independent power supply separate from the recording system 200, the position information outputting apparatus 100 can be separated from the digital recording/reproducing device. Accordingly, in the case of obtaining the position information of the current position of the object without recording the images of the object, since the power is not supplied to the recording system 200, power consumption can be reduced.

According to an embodiment the present invention, it is possible to estimate the position of the object even under the unstable reception, by separately placing the position information outputting apparatus 100 in a place where reception is better. Thus, the position information outputting apparatus 100 receives the data for position calculation from the satellites in a more stable manner. Since the position information outputting apparatus 100 can be separately used, the position information outputting apparatus 100 can store the calculated position information periodically, and thus it is possible to predict the position of the object even when the position information cannot be acquired, by using such stored position information.

Although certain embodiments of the present invention have been disclosed for illustrative purposes, those skilled in the art will appreciate that various modifications, additions and substitutions can be made without departing from the scope and spirit of the invention as disclosed in the accompanying claims.

What is claimed is:

1. A position determining device, adapted for use with an image recording device, the position determining device comprising:
a receiver, adapted to receive data for position calculation;
a calculator, adapted to calculate position information based on said data for position calculation;
a connecting portion comprising a fixing portion, adapted to removably connect to the image recording device, and a transmitting terminal adapted to provide said position information to the image recording device; and
a transmitter, adapted to transmit said position information calculated by said calculator to the image recording device connected to said fixing portion via said transmitting terminal.

2. A position determining device as claimed in claim 1, further comprising:
a power supply, adapted to supplying power to said receiver, said calculator and said transmitter.

3. A position determining device as claimed in claim 1, wherein said receiver is adapted to receive said data from a satellite.

4. A position determining device as claimed in claim 1, wherein:
said fixing portion comprises first and second fixing portions, adapted to couple to each other; and
said transmitting terminal comprises first and second transmitting terminals, adapted to couple to each other when said first and second fixing portions are coupled to each other.

5. A position determining device as claimed in claim 1, wherein said calculator comprises:
an amplifier, adapted to amplify said data received by said receiver and output an amplified signal;
a synchronization device, adapted to output a synchronization signal;
a signal processor, adapted to process said data based on said synchronization signal and output a processed signal; and
a position calculator, adapted to calculate said position information based on said processed signal.

6. A position determining device as claimed in claim 1, wherein:
the image recording device includes a video recording/reproducing device; and
said transmitting terminal is adapted to provide said position information to the video recording/reproducing device.

7. A digital recording/reproducing device, comprising:
an image capturing unit, adapted to capture an image of an object;
a recording unit, adapted to record said image of the object taken by said image capturing unit on a recording medium;
a positing determining device, adapted to receive data for position calculation, and to calculate position information using said data; and
a connecting portion, comprising a fixing portion adapted to removably connect said position determining device to a casing that houses at least one of the image capturing unit and the recording unit therein, and a transmitting terminal adapted to transmit said position information output from said position determining device to said recording unit.

8. A digital recording/reproducing device as claimed in claim 7, wherein:
said connecting portion is provided on a portion of said casing that houses said image capturing unit and said recording unit therein.

9. A digital recording/reproducing device as claimed in claim 7, wherein:
said recording unit is further adapted to record said image of the object on said recording medium together with said position information when said recording unit receives said position information via said transmitting terminal.

10. A digital recording/reproducing device as claimed in claim 7, wherein said position determining device comprises:
a receiver, adapted to receive said data for position calculation;
a calculator, adapted to calculate said position information using said data; and
a transmitter, adapted to transmit said position information calculated by said calculator to said recording unit via said transmitting terminal.

11. A digital recording/reproducing device as claimed in claim 10, wherein said position determining device comprises:
a power supply, adapted to supply driving power to said receiver, said calculator and said transmitter.

12. A digital recording/reproducing device as claimed in claim 7, wherein said position determining device comprises:
a global positioning system (GPS) terminal.
